(19) United States
(12) Patent Application Publication
(10) Pub. No.: US 2018/0073833 A1
(43) Pub. Date: Mar. 15, 2018

(54) SHARK SELF DEFENCE TOOL

(71) Applicant: Eduardo MARQUEZ, Mermaid Beach QLD (AU)

(72) Inventor: Eduardo MARQUEZ, Mermaid Beach QLD (AU)

(21) Appl. No.: 15/698,973

(22) Filed: Sep. 8, 2017

(30) Foreign Application Priority Data
Sep. 10, 2016 (AU) 2016 903 650
Sep. 22, 2016 (AU) 2016 903 839
Dec. 1, 2016 (AU) 2016 904 936

(51) Int. Cl. F41B 15/06; B26B 29/02

(52) U.S. Cl. CPC F41B 15/06; B26B 29/025

(57) ABSTRACT

A tool for defending a person against shark attacks, the tool itself including; a spike; a handle; and a grab wherein the grab is a lanyard with a grip formed in it to facilitate the securement of the grab in the hand of a user when retrieving the tool. In some embodiments, the grip might be a knot or it may be a buoyant element that helps the tool to float. Preferably the tool further includes a sheath for releasable attachment to the spike and/or handle that covers the spike when not in use and apparel that includes means for retaining the tool and sheath. Such apparel includes armbands, wetsuits and swimming tops.

### TECHNICAL FIELD

The present invention relates to tools for fending off attacks from sharks, and more particularly to a compact, low-profile spike which can be easily and safely carried and accessed while surfing or partaking in other water activities.

### BACKGROUND

Surfing and other water sports are popular past times. However, whilst people are enjoying this past time, they are exposed to attacks from the apex predator of the ocean, the shark. Humans have no natural defence against a shark attack.

The International Shark Attack Files (ISAF) investigates and catalogues all shark attacks worldwide. The ISAF recorded 98 unprovoked attacks worldwide in 2015, which was the highest in recorded history. The number of shark attacks on humans is increasing. This is primarily because of over fishing and the consequent collapse of fisheries worldwide. In addition, surfing and water sports are increasing in popularity. Consequently, sharks are turning to humans more often as a food source.

Scuba knives are often used by divers and they are strapped to a divers leg usually. Scuba knives can be used to ward off predators such as sharks, however they come with them many shortcomings, including:
scuba knives can be bulky and difficult to hold in alternate configurations;
the removal of the knives from their holsters can be difficult and require two hands;
the positioning of the knife after removal from a holster into a stabbing configuration requires two movements and the use of two hands;
the knife is heavy and will sink if dropped;
usually strapped to the legs where it is statistically more likely for a bite to occur.

There is more need than ever for effective tools overcome, at least in part, the shortcomings of the prior art.

### SUMMARY OF INVENTION

According to the present invention, there is provided a tool for defending a person against shark attacks, the tool comprising:

(a) a spike;

(b) a handle; and

(c) a grab.

Preferably the grab is a lanyard.

More preferably the grab is a lanyard with a grip formed in it to facilitate the securement of the grab in the hand of a user when retrieving the tool.

Still more preferably the grip is a knot tied into the lanyard.

Alternatively, the grip is a float or other bulbous and buoyant element.

Still more preferably the tool further comprises a sheath for releasable attachment to the spike and/or handle that covers the spike when not in use.

Preferably the spike is less than ⅘th the length of handle.

More preferably the tool is buoyant in water.

Still more preferably the tool and sheath are buoyant in water.

According to a second aspect of the invention there is provided a shark attack defenders kit, wherein the kit comprises of:

(a) a tool comprising of a spike and a handle;

(b) a sleeve adapted to be worn on the upper arm portion of a user; wherein the sleeve is configured to receive and retain the tool in a way that allows the tool to be removed from the sleeve in one pulling movement.

Preferably the kit further comprises a sheath for the spike portion of the tool and wherein the sleeve is adapted to retain the tool including the sheath when spiked and wherein the sleeve is configured to retain the sheath when the tool is removed.

Preferably the sleeve is configured to retain the sheath when the tool is removed by providing an adjustable strap that can tighten the grip of the sleeve on the tool and sheath.

More preferably the tool has a grab.

More preferably the grab is a lanyard with a grip formed in it to facilitate the securement of the grab in the hand of a user when retrieving the tool.

Still more preferably the grip is a knot tied into the lanyard.

Alternatively, the grip is a float or other bulbous and buoyant element.

Preferably the sleeve is made of polychloroprene (NEOPRENE™).

More preferably the tool is buoyant in water.

Still more preferably the tool and sheath are buoyant in water.

According to a third aspect of the invention there is provided a garment for wearing in the water that is adapted to receive and retain a tool comprising at least, a spike and a handle, wherein the garment is configured to have on each upper arm sleeve, means for retaining a tool in a way that allows the tool to be removed from the sleeve in one pulling movement.

More preferably the garment is adapted to retain a tool in each upper arm portion by including pockets, open to the outside of the garment in which at least the tool is inserted.

Still more preferably the garments have pockets for retaining a tool and a sheath for retaining the spike of the tool.

Even more preferably the garment is a wet-suit.

Still more preferably the garment is a wet suit top or short arm wetsuit.

Alternatively, the garment is a rash vest.

Any of the features described herein can be combined in any combination with any one or more of the other features described herein within the scope of the invention.

### BRIEF DESCRIPTION OF DRAWINGS

Various embodiments of the invention will be described with reference to the following drawings, in which:

FIG. 1 is a representation of a tool according to the present invention being used to fend off a shark attack.

FIG. 2 is a close up view of the tool of FIG. 1, wherein the spike is placed within the sleeve.

FIG. 3 is a close up view of the tool of FIG. 1, wherein the spike has been withdrawn from the sleeve.

FIG. 4 is a perspective view of the spike.

FIG. 5 is a perspective view of a wetsuit according to an embodiment of the present invention.

### DETAILED DESCRIPTION

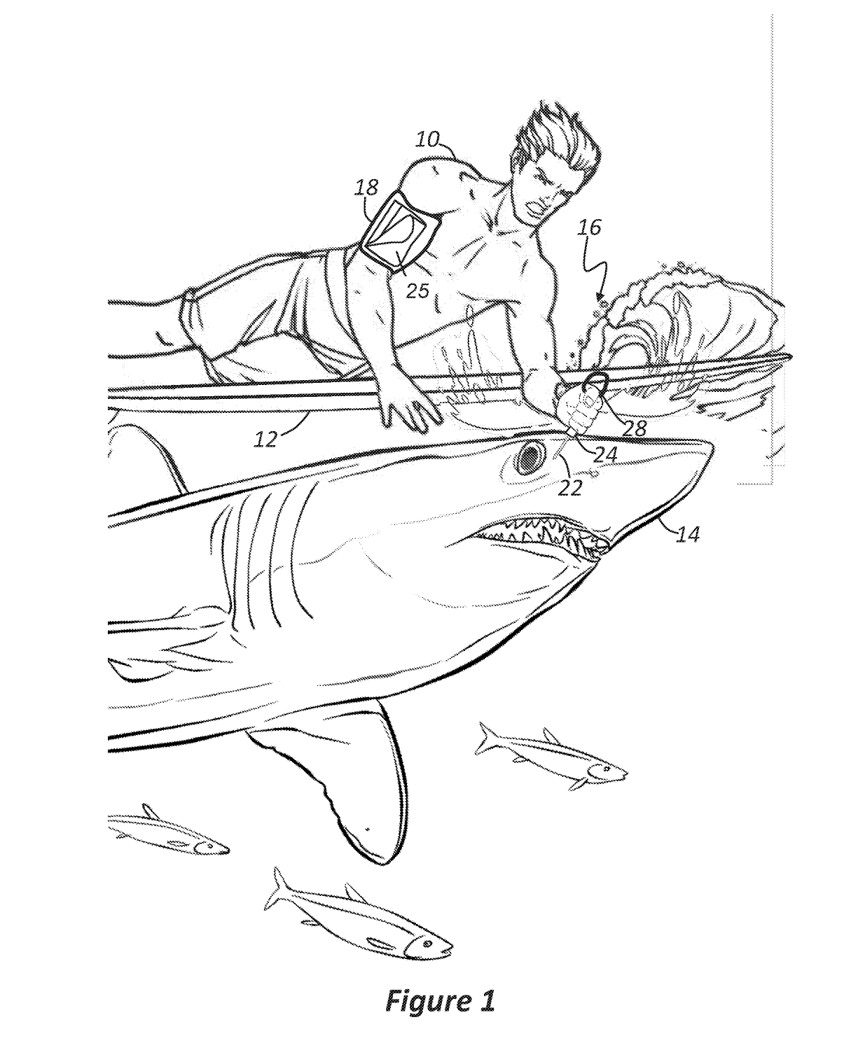

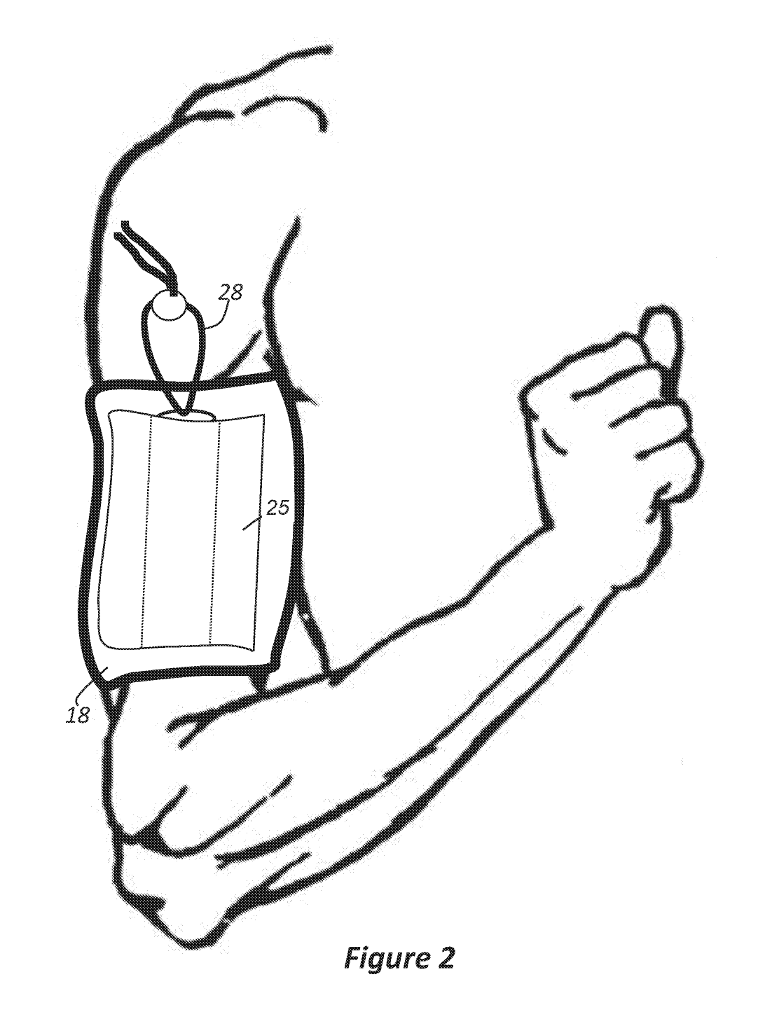

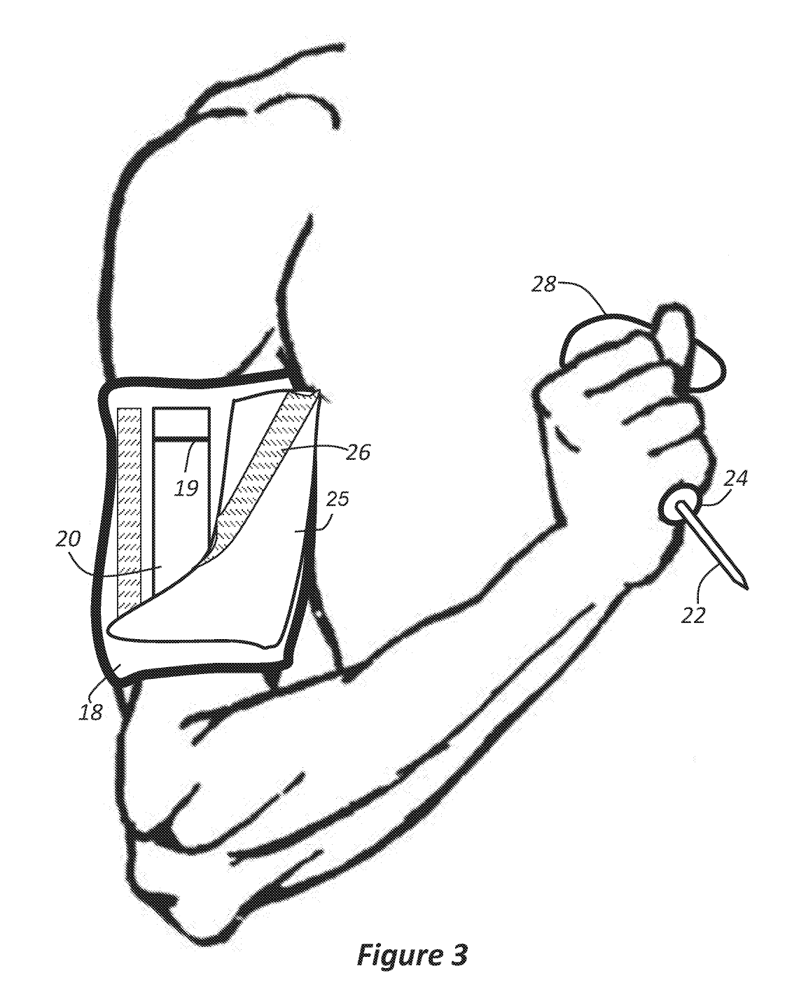

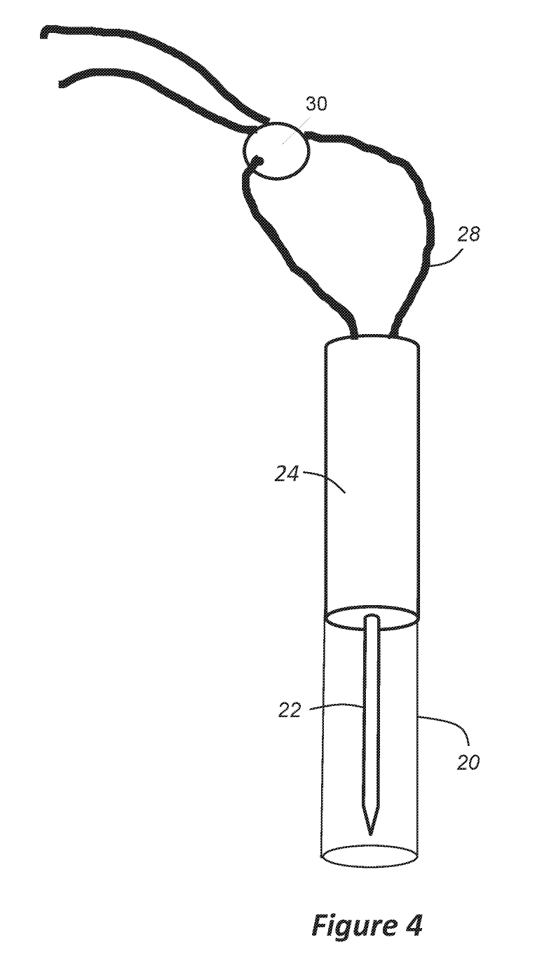

FIGS. 1 to 4 show the first and second aspects of the invention. FIG. 1 shows a person 10 on a board 12 being attacked by a shark 14. The person 10 has a self defence tool 16. The tool 16 has a sleeve 18 which fits on the arm of the person 10. Sheath 20 (shown in FIG. 4) is provided for spike 22 which is permanently attached to a handle 24 of the self defence tool. Sleeve 18 has a pocket 19 in which the sheath 20 sits securely and which also receives the self defence tool 16. The spike 22 slides and secures into the sheath 20 and the handle 24 is held fast by a flap 25. The flap 25 is secured using fastening means including hook and loop fasteners 26.

The handle 24 is configured to have a lanyard 28 which is used to easily remove the self defence tool 16, attached to the body of the handle 24. This may include a loop formed at the end of the handle 24 to attach said lanyard 28. Self defence tool 16 is designed to float in the event that the handle 24 slips out of the grip of the person 10. An additional flotation device 30 can also optionally be attached to the lanyard 28 to keep the self-defence tool 16. The flotation device 30 also functions as a grip for the lanyard. In other embodiments a knot can be formed in the lanyard to provide a grip for the user to retrieve the self defence tool 16 with one pulling movement. Preferably the grip is provided at a distance from the top of the handle that is equal to or less than the average width of a hand such that in use when gripped between the thumb and forefinger, at least some portion of the handle is in the grip of the users hands to facilitate the quick positioning of the self defence tool so that it can be used without having to reposition the device in circumstances in which one arm may be incapacitated.

It is preferably that the spike be no more than ⅘ths the length of the handle. In a more preferred embodiment it is less than ⅔ the length. In a preferred embodiment the length of spike 22 is 55 mm and the thickness of the spike 3 mm. The spike sides are not sharp like a blade and is quite safe to touch, much like a building nail. The handle 24 is, in a preferred embodiment, 80 mm in length and 25 mm in diameter. It can be provided in a cylindrical configuration or it can be moulded to provide contours that assist it being gripped by the user 10. When sheathed, the combined length of the combined sheath 20 and self defence tool 16 should be preferably no more than 150 mm. Beyond this length and the tool will not comfortably sit on the upper arm without impairing the users movement. Further, the legs should not be used as an alternative location to accommodate extra long sized assembly of self defence tool 16 and sheath 20 as it is often the legs that are attacked by a shark first, thereby potentially robbing the user 10 of the opportunity to use the self defence tool 16.

The sheath 20 and self defence tool 16 can be made removably attachable by way of magnets and or gripping portions. The forces that are required to separate the sheath 20 and the self defence tool 16 shall be low so as to not prevent the easy retrieval of the self defence tool 16.

When attacked by shark 14, the person 10 reaches for the self defence tool 16 and pulls the lanyard 28, and withdrawing the handle 24 with the spike 22 from the sheath 20 and sleeve 18 in one movement. The person 10 grips the handle 24 as described above and drives the spike 22 into the shark 14 thereby causing distress to the shark 14 and preventing further attack.

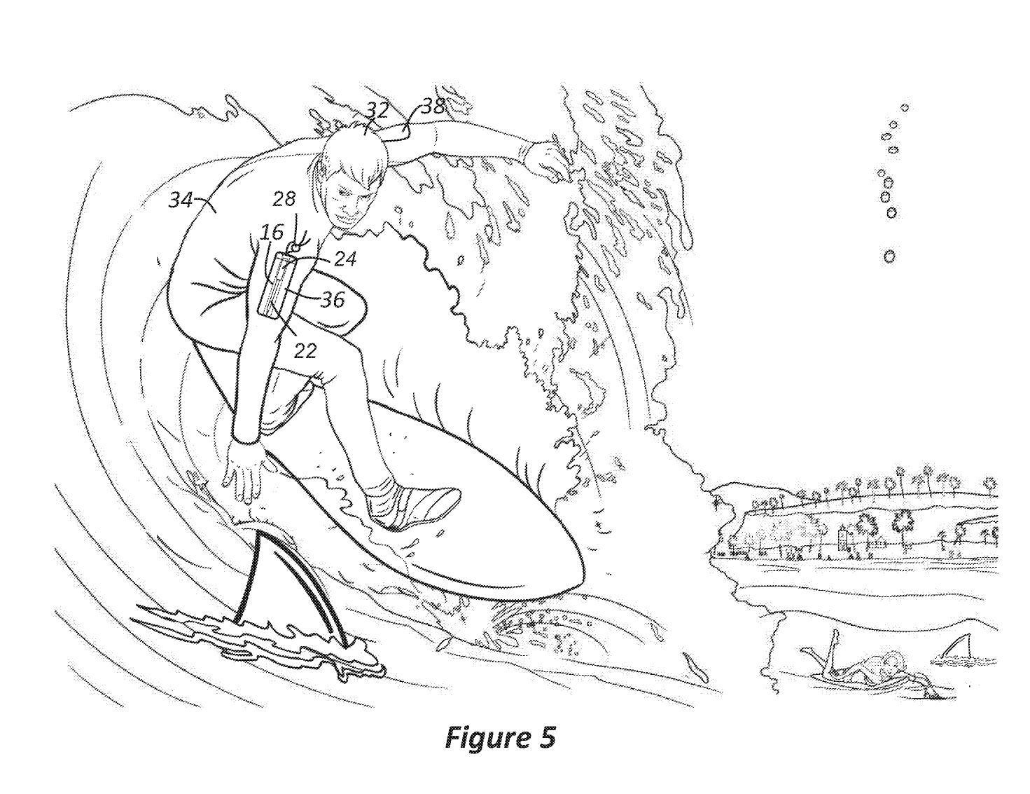

FIG. 5 shows a surfer 32 wearing a wetsuit 34 which is the subject of the third aspect of the invention. Wetsuit 34 has compartments or pockets 36 and 38. Both compartments are adapted to hold the self defence tool 16 of the previous aspects of the invention for fending off shark attacks. They can be adapted to include permanently fixed sheaths for receiving safely the spike 22 or they can be configured to receive a sheath and spike/handle assembly as in the case of sleeve 18. Similar compartments could also be used on a wet suit top or short arm wetsuit or any garment meant to be used in water such as a rash vest.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A tool for defending a person against shark attacks, the tool comprising:
(a) a spike;
(b) a handle which is configured to have attached to it, a grab.

2. The tool of claim 1 wherein a grab is attached to the handle of the tool.

3. The tool of claim 1 wherein the grab is a lanyard which is attached to the handle of the tool.

4. The tool of claim 1 wherein the grab has a grip formed therein to facilitate the securement of the grab in the hand of a user when retrieving the tool.

5. The tool of claim 1 wherein the grip is a knot tied in the lanyard.

6. The tool of claim 1 wherein the grip is a float.

7. The tool of claim 1 wherein the tool further comprises a sheath for releasable attachment to the spike and/or handle that covers the spike when not in use.

8. The tool of claim 1 wherein the spike is less than ⅘th the length of handle.

9. The tool of claim 1 wherein the tool is buoyant in water.

10. A shark attack defenders kit, wherein the kit comprises of:
(a) a tool comprising of a spike and a handle;
(b) a sleeve adapted to be worn on the upper arm portion of a user;
wherein the sleeve is configured to receive and retain the tool in a way that allows the tool to be removed from the sleeve in one pulling movement.

11. The kit of claim 10 wherein the kit further comprises a sheath for the spike portion of the tool and wherein the sleeve is adapted to retain the tool including the sheath when spiked and wherein the sleeve is configured to retain the sheath when the tool is removed.

12. The kit of claim 11 wherein the kit the sleeve is configured to retain the sheath when the tool is removed by providing an adjustable strap that can tighten the grip of the sleeve on the tool and sheath.

13. The kit of claim 10 wherein the grab is a lanyard with a grip formed in it to facilitate the securement of the grab in the hand of a user when retrieving the tool.

14. The kit of claim 13 wherein the grip is a knot tied into the lanyard.

15. The kit of claim 13 wherein the grip is a float.

16. The kit of claim 13 wherein the sleeve is made of polychloroprene.

17. The kit of claim 10 wherein the tool is buoyant in water.

18. A garment for wearing in the water that is adapted to receive and retain a tool comprising at least, a spike and a handle, wherein the garment is configured to have on each upper arm sleeve, means for retaining a tool in a way that allows the tool to be removed from the sleeve in one pulling movement.

19. The garment of claim 18 wherein the garment is adapted to retain a tool in each upper arm portion by including pockets, open to the outside of the garment in which at least the tool is inserted.

20. The garment of claim 19 wherein the garments have pockets for retaining a tool and a sheath for retaining the spike of the tool.

21. The garment of claim 18 wherein the garment is a wet suit.

22. The garment of claim 18 wherein the garment is a wet suit top or short arm wetsuit.

23. The garment of claim 18 wherein the garment is a rash vest.
